(19) United States
(12) Patent Application Publication
(10) Pub. No.: US 2009/0121607 A1
(43) Pub. Date: May 14, 2009

(54) FILAMENT LAMP AND LIGHT IRRADIATION TYPE HEAT TREATMENT DEVICE

(75) Inventors: Kenji TANINO, Himeji-shi (JP); Yoichi MIZUKAWA, Himeji-shi (JP); Shinji SUZUKI, Tokyo-to (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignee: USHIODENKI KABUSHIKI KAISHA, Tokyo (JP)

(21) Appl. No.: 12/265,423

(22) Filed: Nov. 5, 2008

(30) Foreign Application Priority Data
Nov. 8, 2007 (JP) 2007-290823

(51) Int. Cl. H01K 9/00

(52) U.S. Cl. 313/316

(57) ABSTRACT

A filament lamp and light irradiation type heat treatment device capable of uniformly thermally processing the entirety of an article to be treated has a filament lamp (100) in which coil-shaped filaments are disposed along the tube axis within a light emitting tube (102), wherein the filaments are electrically connected to a low-emission coil (F2″) having a relatively smaller effective surface area and to high-emission coils (F1″, F1″) having relatively large effective surface areas, with the low-emission coil disposed in between in the axis of the tube direction, and a light irradiation type heat treatment device utilizing the filament lamp (100).

### BACKGROUND OF THE INVENTION

1. Field of Invention

This invention relates to a filament lamp and a light irradiation type heat treatment device, and in particular, to a filament lamp and a light irradiation type heat treatment device used to thermally process semiconductor wafers and other articles to be treated.

2. Description of Related Art

Thermal processing is widely employed in various steps that are part of the semiconductor manufacturing process, including film formation, oxidation, nitriding, film stabilization, silicidation, crystallization, and ion injection activation. In order to improve efficiency and product quality in semiconductor manufacturing processes, rapid thermal processing (RTP), in which the temperature of semiconductor wafers or other articles to be treated is rapidly raised and lowered, is desirable. Light irradiation type heat treatment devices (referred to hereafter simply as heat treatment devices) that use light irradiation from light sources such as incandescent lamps are widely used in RTP.

Here, when the article to be treated is a semiconductor wafer (silicon wafer), for example, when the semiconductor wafer is heated to at least 1050° C., non-uniformity occurs in the temperature distribution on the semiconductor wafer. This phenomenon is referred to as slip, or in other words, defects in crystal transition, which can result in a defective product. Accordingly, in a case in which semiconductor RTP is performed using a light irradiation type heat treatment device, the heating, keeping at a high temperature and cooling must be performed so that the temperature distribution is uniform across the entire surface of the semiconductor wafer. In other words, in RTP, high-precision temperature uniformity is needed for the article to be treated.

In order to perform this rapid thermal processing, a light irradiation type heat treatment device is employed, configured with a plurality of filament lamps, each having a plurality of coiled filaments of differing lengths disposed in the interior of a light emitting tube, configured as a surface light source with the filaments corresponding to the shape of the article to be treated.

FIG. 13 shows the configuration of a lamp unit 200 to which the light irradiation type heat treatment device according to conventional technology has been applied.

As shown in the drawing, in order to heat the article W to be treated so the temperature distribution is uniform on the surface of the article W to be treated, the electric power applied to a filament lamp 210 is adjusted so that the electric power applied to a filament F2 on the filament lamp 210 corresponding to an edge zone Z2 peripheral to the center of the article to be treated is greater, considering that thermal radiation from the peripheral of the article W to be treated occurs. Specifically, the rated power density in the filament F2 in the filament lamp 210 disposed corresponding to the peripheral zone Z2 of the article W to be treated is increased in relation to the rated power density in a filament F1 of the filament lamp 210 disposed corresponding to the center zone Z1 of the article W to be treated.

Simultaneously, each filament lamp 210 is designed so that the rated power density of a filament 220 disposed corresponding to each zone Z1 and Z2 is identical for each zone Z1 and Z2, so the strength of the light emitted on each zone Z1 and Z2 of the article W to be treated is uniform. To offer an example, the lamp is designed so that each filament F2 disposed corresponding to the peripheral zone Z2 of the article W to be treated has the same rated power density of 100 W/cm, while each filament F1 disposed corresponding to the center zone Z1 of the article to be treated has the same rated power density of 50 W/cm; see, for example, JP-A-2006-279008 and corresponding US 2006/197454 A1.

However, the fact has been shown that, when a article to be treated is thermally processed using the light irradiation type heat treatment device described above, it is impossible to heat the silicon (Si) substrate or other article to be treated so that the surface temperature is uniform. In other words, the fact has been shown that when the mass and surface area of a filament are identical per each unit of length of each independently powered filament, in order to heat the article to be treated uniformly, increasing the power density per unit of length of filaments corresponding to the center zone of the article to be treated in relation to the power density per unit of length of filaments corresponding to the peripheral zone of the article to be treated shifts the spectrum of the light emitted from the filaments corresponding to the peripheral zone toward shorter wavelengths than filaments corresponding to the center zone of the article to be treated, and the energy ratio on the shorter wavelength side will occupy a greater portion of the overall irradiance.

FIG. 14 shows a spectral irradiance comparison in a case in which the total irradiance is identical (equivalent to making the power density identical). The drawing shows that if the color temperature (in other words, the filament surface temperature) differs even when the total energy emitted is the same, the spectral irradiance differs for each wavelength. The term “color temperature” here expresses the color of light at the temperature of a black body. In a case in which filament materials are identical (tungsten, in this example), filament surface temperature values and color temperature values of light from the filaments have a 1:1 correspondence. Since the relationship between surface temperature and the color temperature of emitted light from that surface has been calculated in advance, the color temperature of the light may be calculated and used in place of the surface temperature of the filament. In other words, when the mass and surface area of the filaments per unit of length are identical, a higher power density supplied per unit of length of the filaments raises the filament temperature, while a lower power density per unit length of the filaments lowers the filament temperature. With the raising and lowering of the temperature, the phenomenon occurs of shifting toward shorter wavelengths of the wavelength of light emitted from the filaments, as shown in FIG. 14.

FIG. 15 shows the absorbance properties (the transmittance for light wavelength) at each wavelength for silicon (Si), gallium arsenide (GaAs), and germanium (Ge). The vertical axis indicates transmittance (%), while the horizontal axis shows light wavelength (μm). The illustration shows an absorbance property when the article to be treated is silicon (Si) exhibiting a rapid change in transmittance from 0% to 100% from 1 μm to 1.2 μm. In other words, silicon (Si) powerfully absorbs light with a wavelength of 1 μm or less, while it transmits nearly all light with a wavelength of over 1.1 μm.

Consequently, when filaments corresponding to the central zone of the article to be treated have a strong irradiance for light with a wavelength of over 1.1 μm and filaments corresponding to the peripheral zone of the article to be treated have a strong irradiance for a wavelength of 1 μm or less, the ratio of the power density per unit of length of the filaments corresponding to the central zone of the article to be treated to the power density per unit of length of the filaments corresponding to the peripheral zone of the article to be treated does not have a proportional relationship to the ratio of the thermal dose of the peripheral zone to the central zone of the article to be treated. In other words, since the wavelengths of the emitted light differ, the central zone of the article to be treated is more weakly heated because more light passes through and less is absorbed, while the peripheral zone of the article to be treated heats rapidly because less light passes through and more light is absorbed. As a result, a temperature differential occurs between the central zone and the peripheral zone of the article to be treated, and for this reason, heating the article to be treated so the temperature distribution is uniform on the surface of the article to be treated is believed impossible.

### SUMMARY OF THE INVENTION

Taking note of the problems noted above, an object of the present invention is to provide a filament lamp and a light irradiation type heat treatment device capable of heating the entirety of a article to be treated uniformly.

The present invention has adopted the following means for solving the problems noted above.

The first means is a filament lamp having a coil-shaped filament disposed extending along the tube axis in a light emitting tube, wherein the filament is electrically connected to a low radiance coil having a relatively small effective surface area and to a high radiant coil having a relatively large effective surface area, on which the low radiance coil element is disposed on both sides in the tube axis direction.

The second means is a filament lamp in which a plurality of filaments, to which are linked a pair of leads for supplying electric power to said filament at both ends of the coil-shaped filament in the interior of a light emitting tube upon which a hermetically sealed portion is formed on at least one end, are disposed with each filament extending along the tube axis of the light emitting tube. Each lead is electrically connected to electrically conductive parts disposed in each hermetically sealed portion, wherein the filament lamp comprises a low radiance coil having a relatively small effective surface area and a high radiance coil having a relatively large effective surface area, on which the low radiance coil element is disposed on both sides in the tube axis direction. A “relatively small” effective surface area here means that the surface area is smaller than the “relatively large” effective surface area, and vice versa. That is, the effective surface area of the low radiance coil is smaller than the effective surface area of the high radiance coil.

The third means is a light irradiation type heat treatment device having a plurality of filament lamps in which coil-shaped filaments extending along the tube axis inside a light emitting tube, are disposed so as to comprise a surface light source, wherein the effective surface area per unit length of the filaments in the filament lamps disposed corresponding to the outer edge zone of the article to be treated is greater than the effective surface area per unit length of filaments disposed corresponding to center zone of the article to be treated.

The fourth means is a light irradiation type heat treatment device wherein a plurality of filament lamps having a plurality of filaments, to which are linked a pair of leads for supplying electric power to said filament at both ends of the coil-shaped filament in the interior of a light emitting tube upon which a hermetically sealed portion is formed on at least one end are disposed with each filament extending along the tube axis of the light emitting tube, wherein each lead is electrically connected to electrically conductive parts disposed in each hermetically sealed portion, are disposed so as to comprise a surface light source, wherein the filament lamps comprise a low radiance coil having a relatively small effective surface area and a high radiance coil having a relatively large effective surface area, on which the low radiance coil element is disposed on both sides in the tube axis direction.

The fifth means is a light irradiation type heat treatment device of the third means or the fourth means wherein, in the filament lamps, the external diameter of each of the filament coils disposed corresponding to the outer edge zone of the article to be treated is smaller than the pitch of each of the filament coils disposed corresponding to the center zone of the article to be treated.

The sixth means is a light irradiation type heat treatment device of the third means or the fourth means, wherein in the filament lamps the pitch of each of the filament coils disposed corresponding to the outer edge zone of the article to be treated is smaller than the pitch of each of the filament coils disposed corresponding to the center zone of the article to be treated.

The seventh means is the light irradiation type heat treatment device of the third means or the fourth means, wherein in the filament lamps the strand diameter of each of the filaments disposed corresponding to the outer edge zone of the article to be treated is greater than the strand diameter of each of the filament coils disposed corresponding to the center zone of the article to be treated.

The eighth means is a light irradiation type heat treatment device upon which a plurality of the filaments lamps described in the first means are disposed so as to comprise a surface light source, wherein said low radiance coil is disposed facing the center of the article to be treated, and said high radiance coil is disposed facing the outer edge of the article to be treated.

The ninth means is the light irradiation type heat treatment device of the eighth means, wherein the coil external diameter of the high radiance coil is larger than the coil external diameter of the low radiance coil.

The tenth means is the light irradiation type heat treatment device of the eighth means, wherein the coil pitch of the high radiance coil is smaller than the coil pitch of the low radiance coil.

The eleventh means is the light irradiation type heat treatment device of the eighth means, wherein the strand diameter of the high radiance coil is larger than the strand diameter of the low radiance coil.

The twelfth means is the light irradiation type heat treatment device of any one of the third means through the eleventh means, wherein each of the filaments disposed in the area corresponding to the outer edge zone of the article to be treated and each of the filaments disposed in the area corresponding to the center zone of the article to be treated has the same effective surface area in each of the respective zones.

According to the invention, it is possible to realize a filament lamp capable of heating an article to be treated so the temperature distribution is uniform on the entire surface of the article to be treated because, in a case in which the color temperature of the low radiance coil and the high radiance coil is kept constant, it is possible to increase the emission intensity from the high radiance coil in relation to the emission intensity from the low radiance coil, and it is possible to make the shape of the emission spectrum of the low radiance coil identical to the shape of the emission spectrum of the high radiance coil.

In addition, according to the invention, it is possible to realize a filament lamp capable of heating an article to be treated so the temperature distribution is uniform on the entire surface of the article to be treated because, in a case in which the color temperature of the low radiance coil (low radiance filaments) and the high radiance coil (high radiance filaments) is kept constant, it is possible to increase the emission intensity from the filaments with a larger effective surface area per unit of filament length in relation to the emission intensity from the filaments with a smaller effective surface area per unit of filament length, and it is possible to make the radiant spectral shapes of both filaments identical.

### BRIEF DESCRIPTION OF THE DRAWINGS

FIG. 1 is a front sectional view showing the configuration of a light irradiation type heat treatment device according to the first embodiment.

FIG. 2 is a view from above of the configuration of the lamp unit shown in FIG. 1.

FIG. 3 is a perspective view showing the configuration of the filament lamp shown in FIG. 2.

FIGS. 4(a) & 4(b) are schematic sectional views extending along the tube axis plane of a filament strand in the filament formed by winding into the coil shape shown in FIG. 3.

FIG. 5 is a schematic sectional view extending along the tube axis plane of the filaments formed by winding into the coil shape shown in FIG. 2.

FIG. 6 is a schematic sectional view extending along the tube axis plane of the filaments formed by winding into the coil shape shown in FIG. 2, differing from that shown in FIG. 5.

FIG. 7 is a schematic sectional view extending along the tube axis plane of the filaments formed by winding into the coil shape shown in FIG. 2, differing from that shown in FIG. 5.

FIG. 8 is a view showing the configuration of a lamp unit configured by disposing the lamp unit shown in FIG. 2, mutually in upper and lower rows in a grid., in place of the configuration of the lamp unit shown in FIG. 2.

FIG. 9 is a view showing the configuration of a lamp unit according to the second embodiment.

FIG. 10 is a perspective view showing the configuration of the filament lamp shown in FIG. 9.

FIG. 11 is a perspective view showing the configuration of a filament lamp according to the third embodiment.

FIG. 12 is a view showing the configuration of a lamp unit applied to the same type of apparatus as the light irradiation type heat treatment device shown in FIG. 1, with the filament lamp shown in FIG. 11 applied as a lamp unit.

FIG. 13 is a view showing the configuration of a lamp unit 200 applied to a light irradiation type heat treatment device according to conventional technology.

FIG. 14 is a view comparing spectral irradiance in a case in which total irradiance is identical.

FIG. 15 is a view showing the absorbance properties (the transmittance for light wavelength) at each wavelength for silicon (Si), gallium arsenide (GaAs), and germanium (Ge).

### DETAILED DESCRIPTION OF THE INVENTION

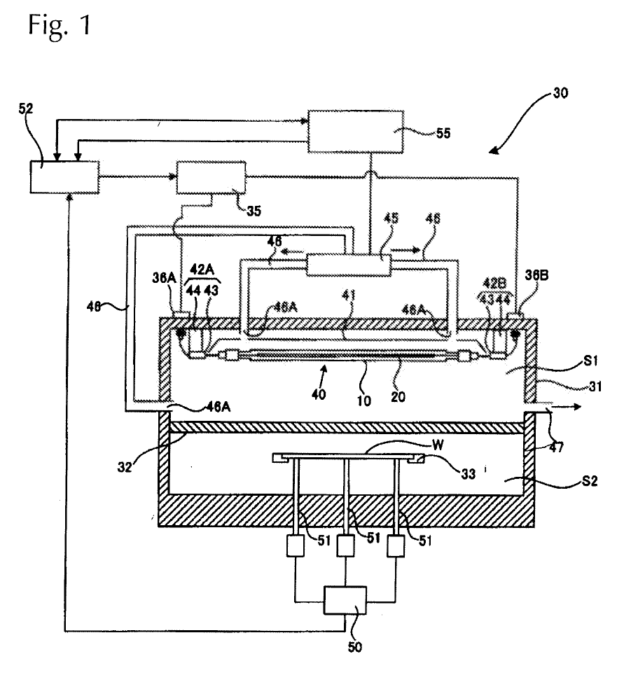

First, an embodiment of the present invention will be described using FIGS. 1 through 8.

FIG. 1 is a frontal sectional view showing the configuration of a light irradiation type heat treatment device according to a first embodiment.

As shown in the drawings, a light irradiation type heat treatment device 30 has a chamber 31 divided by a quartz window 32 into a lamp unit holding space S1 and a thermal processing space S2. The chamber 31 is made up of stainless steel or other metal material. Thermal processing is performed by radiating light emitted from a lamp unit 40, disposed in the lamp unit holding space S1, onto the article W to be treated that is disposed in the thermal processing space S2.

Disposed above the lamp unit 40 is a reflective mirror 41. The reflective mirror 41 has a structure of a main material of non-oxidized copper coated with gold, for example, with a mirror image cross section having a form with a circular portion, an elliptical portion, a parabolic section, or a planar shape. The reflective mirror 41 is oriented upward from the lamp unit 40 to reflect emitted light onto the article W to be treated. In other words, in this apparatus 30, light emitted from the lamp unit 40 is emitted directly or reflected via the reflective lamp 41 and is projected onto the article W to be treated.

Cooling air from a cooling air unit 45 is introduced into the lamp unit holding space S1 from an outlet 46A of a cooling air supply nozzle 46 disposed in the chamber 31. The cooling air introduced into the lamp unit holding space S1 blows onto each filament lamp 10 in the lamp unit 40, cooling the light emitting tubes that make up each filament lamp 10. Here, the hermetically sealed portion of each filament lamp 10 has a low heat resistance compared to other locations. As a result, it is preferable to configure the apparatus so that the outlet 46A of the cooling air supply nozzle 46 is disposed opposite the hermetically sealed portion of each filament lamp 10 in order to preferentially cool the hermetically sealed portion of each filament lamp 10.

The cooling air that has blown onto the filament lamps 10 and has risen in temperature from heat exchange is discharged from a cooling air discharge opening 47 disposed in the chamber 31. The flow of the cooling air is designed so the cooling air that has been heated by heat exchange will not conversely heat the filament lamps. In addition, the flow of the cooling air is arranged to simultaneously cool the reflective mirror 41 as well. In a case in which the reflective mirror 41 is water cooled by a chilled water mechanism (not shown), the flow of the cooling air need not be arranged to simultaneously cool the reflective mirror 41.

If heat accumulation occurs in the quartz window 32 due to radiant heat from the heated article W to be treated, an unwanted heating action can occur in the article W to be treated due to thermal radiation emitted secondarily from the quartz window 32 heated by irradiation. In this case, heat controllability redundancy for the article W to be treated (for example, an overshooting in which the temperature of the article to be treated rises above the set temperature) and reduction in temperature uniformity in the article W to be treated resulting from temperature unevenness in the heated quartz window 32 itself occur. In addition, increasing the speed of the temperature decline of the article W to be treated becomes difficult. As a result, in order to prevent these anomalies, it is preferable to dispose the outlet 46A of the cooling air supply nozzle 46 in the proximity of the quartz window 32 so that the quartz window 32 is cooled by cooling air from the cooling air unit 45, as shown in FIG. 1.

Each filament lamp 10 in the lamp unit 50 is supported by a pair of support frames 42A, 42B. The support frames 42A, 42B are made up of a conductive plate 43 formed of an electrically conductive part and a holding plate 44 formed of ceramic or another insulating member. The holding plate 44 is disposed on the inner wall of the chamber 31 and supports the conductive plate 43.

Disposed in the chamber 31 are a pair of power supply ports 36A, 36B to which a power supply line is connected from a power supply apparatus in a power unit 35. In FIG. 1, one grouping of the power supply ports 36A, 36B is shown, but the number of power supply ports 36 is determined based on the number of filament lamps. The power supply ports 36A, 36B are electrically connected to each conductive plate 43, which are electrically connected to external leads of the filament lamps 10. By configuring the apparatus in this manner, it is possible to supply power from each power supply apparatus in the power unit 45 to each filament lamp 10 in the lamp unit 40.

A processing plate 33 to which the article W to be treated is attached is disposed in the thermal processing space S2. If the article W to be treated is a semiconductor wafer, for example, the processing plate 33 is a thin-sheet circular object composed of molybdenum, tungsten, tantalum or other high-melting point metal material along with a ceramic material such as silicon carbide (SiC), or quartz or silicon (Si), preferably with a guard ring structure on which is formed a step element supporting the semiconductor wafer in the inner perimeter of a round opening. The semiconductor wafer that is the article W to be treated is disposed so the semiconductor wafer will fit into the round opening in the circular guard ring, supported by the step element described above. The processing plate 33 spontaneously rises in temperature due to radiation emission, providing auxiliary radiant heating to the periphery of the facing semiconductor wafer, supplementing heat radiation from the peripheral edge of the semiconductor wafer. As a result, temperature drop in the semiconductor wafer periphery due to thermal radiation from the peripheral edge of the semiconductor wafer is inhibited.

A temperature measurement unit 51 is disposed in contact with or in proximity to the article W to be treated on the side opposite the radiation-receiving surface of the article W to be treated disposed on the processing plate 33. The temperature measurement unit 51 is intended to monitor the temperature distribution on the article W to be treated, with the number and disposition of units determined by the dimensions of the article W to be treated. A thermocouple or radiation thermometer, for example, can be used as the temperature measurement unit 51. The thermometer unit 51 transmits to a thermometer 50 observed temperature information at predefined time intervals (once per second, for instance). The thermometer 50 calculates the temperature at the spot measured by each temperature measurement unit 51 based on the temperature information transmitted from each temperature measurement unit 51, and sends the calculated temperature information to a main control unit 55 via a temperature control unit 52.

The main control unit 55 sends instructions to the temperature control unit 52 based on temperature information obtained by the thermometer 50 for each spot measured on the article W to be treated so the temperature of the article W to be treated will be uniform at a prescribed temperature. In addition, the temperature control unit 52 adjusts the electrical energy supplied to the filament lamp 10 based on the instructions from the main control unit 55 so that the temperature of the two zones Z1 and Z2 into which the article W to be treated is divided will become uniform, as will be discussed hereafter.

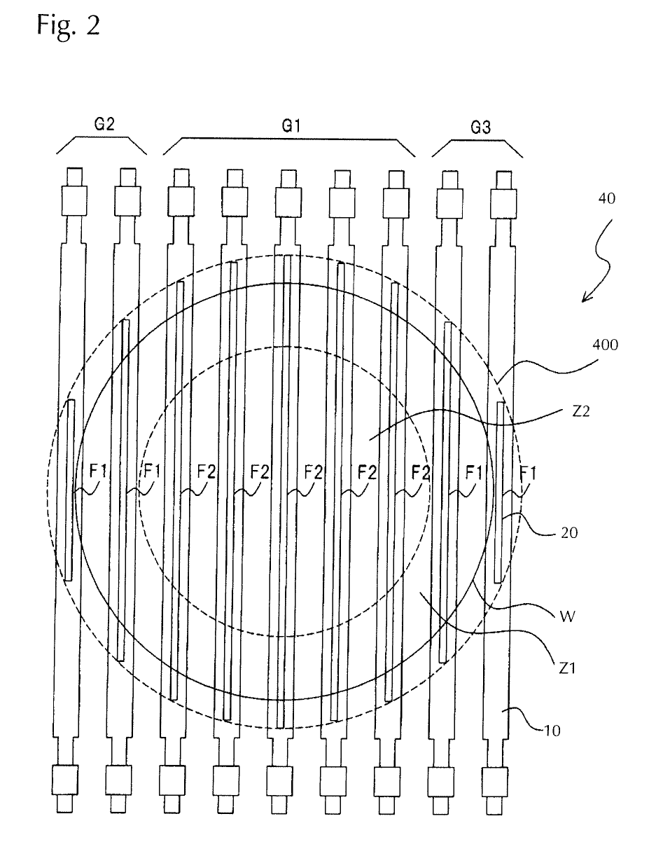

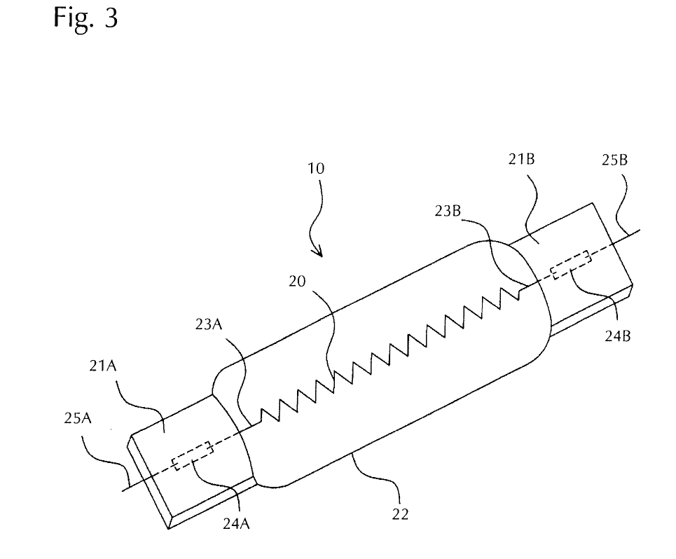

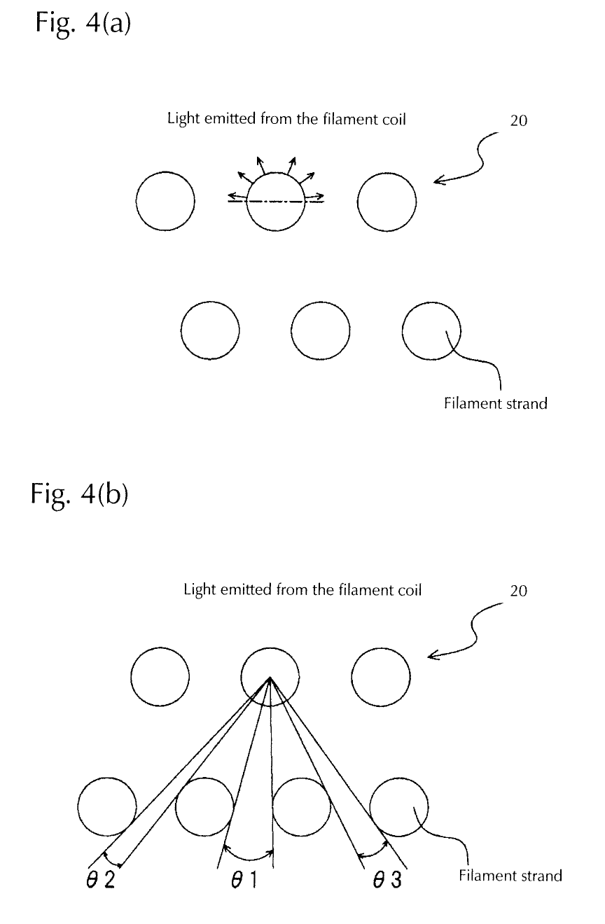

FIG. 2 shows a view from above of the configuration of the lamp unit 40 shown in FIG. 1. FIG. 3 shows a perspective view of the configuration of the filament lamp 10 shown in FIG. 2. FIGS. 4(a) & 4(b) shows a cutaway view, along a plane running through the tube axis, of the filament strand of the filament 20 formed in a coil shape as shown in FIG. 3.

As shown in FIG. 3, the filament lamp 10 has a light emitting tube 22 composed of glass material, for instance, upon which are formed hermetically sealed portions 21A and 21B on both ends. The interior space of the light emitting tube 22 is injected with halogen gas, for example. The coil-shaped filaments 20 formed by wrapping filament strands of tungsten, for example, into a coil shape are disposed extending along the tube axis of the light emitting tube 22. Formed on each end are leads 23A, 23B, connected via metal foils 24A, 24B to external leads 25A, 25B.

In addition, when light from the filament strands is emitted externally from the filament strands as shown in FIG. 4(a), the light is described as the sum of that light and light emitted from those filament strands through the adjacent space between filament strands (angles θ1, θ2, θ3, . . . as viewed from the filament strands) FIG. 4(b).

As shown in FIG. 2, the lamp unit 40 is configured with 9 filament lamps 10, for example, disposed in a row at a prescribed distance apart (for instance, 15 mm) on the same plane as the lamp center axis. The end in the center axis direction of each filament 20 in each filament lamp 10 is disposed extending above the imaginary circle 400 on the outside of the periphery of the article W to be treated, configured so that the total length mutually differs in the center axis direction. Specifically, since the 9 filaments 20 possessed by the 9 filament lamps 10, the filaments having different total lengths in the center axis direction, are disposed in a row on the same plane at a prescribed distance apart, a concentric circular surface light source is constituted with the article W to be treated.

When the article W to be treated is thermally processed, the article W to be treated is divided into 2 zones, for example: a peripheral zone Z1 and a center zone Z2. Illumination control of each filament lamp 10 is performed so as to obtain a prescribed temperature distribution for each zone Z1, Z2. In order to carry out this temperature distribution control on the article W to be treated, the lamp unit 40 is configured with a lamp group G1, formed of a plurality of filament lamps 10 disposed across the peripheral zone Z1 and the center zone Z2 of the article W to be treated, and lamp groups G2, G3, formed of respective pluralities of filament lamps 10 disposed on both sides of the lamp group G1.

The apparatus is configured so that the effective surface area S per unit of length for each of the filaments F1 in each of the filament lamps belonging to the lamp groups G2, G3 is larger than the effective surface area S per unit of length in each of the filaments F2 in each of the filament lamps 10 belonging to the lamp group G1. The effective surface area S is the value of the surface area per unit of length observable from the outside of the filament in the center axis direction of the filament 20. In other words, the effective surface area S is the area of the surface contributing to the light emitted to the outside from the filament 20 without being shielded by the filament itself, relative to the total surface area of the filaments 20 (this point will be discussed in detail hereafter). Here, the effective surface area of the filaments F1 is increased in relation to the effective surface area of the filaments F2 for the following reason.

As discussed previously, in order to perform rapid thermal processing on the article W to be treated with uniform temperature distribution on the surface of the article W to be treated, the intensity of the light emitted onto the peripheral zone Z1 of the article W to be treated must be increased relative to that of the center zone Z2. However, as discussed above, conventionally this need has been addressed by making the rated power density of each filament F1 disposed facing the peripheral zone Z1 of the article W to be treated identical, by making the rated power density of each filament F2 disposed facing the center edge zone Z2 of the article W to be treated identical, and by making the rated power density of each filament F1 greater than that of each filament F2. However, since a temperature differential occurs between zone Z1 and zone Z2, an anomaly occurs so that heating the article W to be treated with a uniform temperature distribution on the surface of the article W to be treated is impossible. The present invention is based upon having obtained the knowledge that the emission intensity of light emitted by the filaments 20 is dependent upon a completely different cause from the rated power density, as shown in equation 1 and equation 2 below.

In other words, as shown in equation 1, the emission intensity E per unit of length from the filaments is determined principally by two causes: the effective surface area S of the filaments, and the color temperature T of the filaments when the filament lamp is operated. ε in equation 1 is obtained from a fixed value dependent on the material. σ is the Stefan-Boltzmann constant (5.6697*10⁻⁸ W/m²*K). Consequently, in equation 1, if the filament color temperature is kept constant, the emission intensity E from the filaments is proportional to the effective surface area S of the filaments.

E=S*ε*σ*T⁴ (Equation 1)

When the wavelength-specific emission intensity is applied using a Planck distribution equation:

B(λ)=(2hc²/λ⁵)*(1/(e^{hc/λkT}−1)) (Equation 2)

B (λ) is the emission intensity of a black body at wavelength λ, λ is the wavelength, h is the Planck constant, c is the speed of light, and k is the Boltzmann constant.

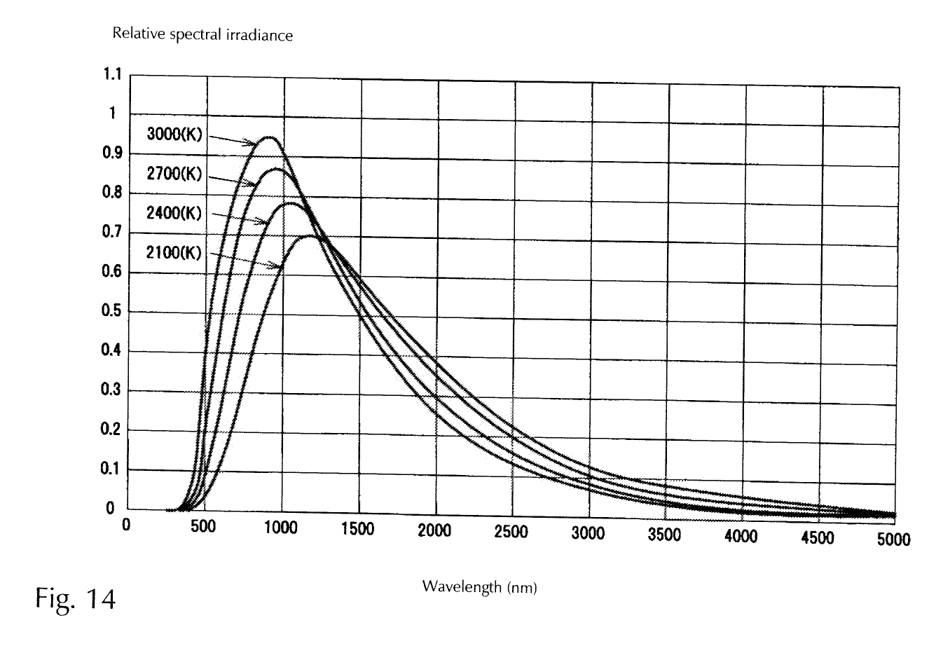

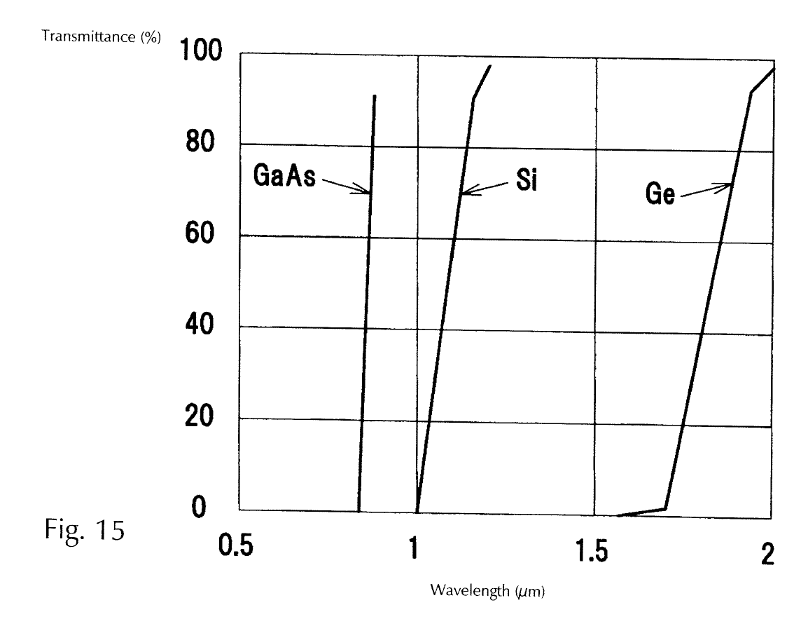

In other words, in the lamp unit 40, by making the temperature of all the filaments 20 belonging to the same zone uniform, that is, by making the color temperature of the light emitted from the filaments 20 uniform, and by having the effective surface areas S_{F1} and S_{F2} of each of the filaments F1, F2 satisfy the relationship shown below, the emission intensity E_{F1} emitted from each of the filaments F1 can be increased relative to the emission intensity E_{F2} emitted from each of the filaments F2, and the shape of the emission spectrum in each of the filaments F1 can be made identical to the shape of the emission spectrum in each of the filaments F2 (see, FIG. 14).

### (Relationship 1)

Effective surface area S_{F1} of each filament F1>effective surface area S_{F2} of each filament F2

In order to make the color temperature of the filaments F1 identical to the color temperature of the filaments F2 in the lamp unit 40, the rated power density for the filaments F1 and F2 should be set to satisfy relationship 2 shown below, since the emission intensity in equation 1 above has essentially the same value as the rated power density applied to the filaments.

### (Relationship 2)

Rated power density M_{F1} of the filaments F1>rated power density M_{F2} of the filaments F2
M_{F1}/M_{F2}=S_{F1}/S_{F2}

Here, the values of the effective surface areas S_{F1}, S_{F2} are determined based on equation 3 and equation 4 below.

S=2πRL*K (Equation 3)

R is the radius of the filament strand, and L is the total length of the filament strand.

K=180°/360°+(θ1+θ2+ . . . +θn)/180° (Equation 4)

See, FIG. 4(b) regarding θ1, θ2 . . .

Equation 3 gives the effective surface area per unit of length of the filaments configured with the filament strands wound into a coil shape. The effective surface area S of the filaments is determined by multiplying 2πRL, representing the surface area of filament strands with a round cross-sectional area in the radial direction by the coefficient K that is given by Equation 4.

Equation 4 gives the total sum of the proportion of light emitted from filament strands disposed on the outside of the filament coil and the proportion of light emitted from filament strands disposed on the inside of the filament coil. Described in greater detail, the first half of Equation 4 represents the proportion of light emitted from filament strands disposed on the outside of the filament coil, while the latter half of Equation 4 represents the proportion of light emitted to the outside of the filaments without being shielded by filament strands disposed in the light progression direction.

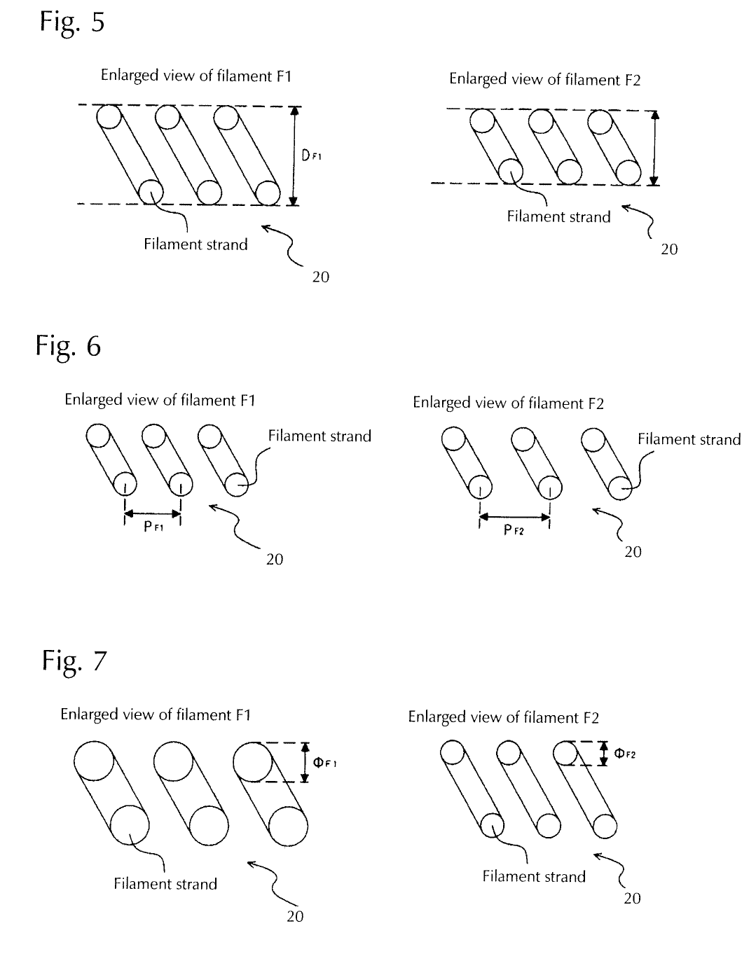

FIG. 5 is a sectional view of a plane along the tube axis of the filaments F1, F2 wound into a coil shape as in FIG. 2.

As discussed in connection with Relationship 1, the effective surface area S_{F1} of each filament F1 is configured so as to be greater than the effective surface area S_{F2} of each filament F2. As a result, as shown in FIG. 5, the outer coil diameter of each filament F1 is increased in relation to the outer coil diameter of each filament F2. Here, the phrase “outer coil diameter” refers to the distance between 2 parallel lines when the outer edge of the filament is bisected by 2 parallel lines in a section portioning the filament on a center plane including the center axis of the filament.

Specifically, if D_{F1} represents the outer coil diameter of the filaments F1 and the outer coil diameter of the filaments F2 is represented by D_{F2}, it is preferable to configure the filaments F1 and the filaments F2 to satisfy the relationship D_{F1}/D_{F2}=1.53 to 2.45. If the value falls below this range, anomalies will occur in that it will be impossible to obtain the desired surface area, the input power will be insufficient, and the temperature at the wafer edge will fall. Also, if the value rises above this range, the outer coil diameter D_{F1} of the filaments F1 will be too large, the filaments will be too heavy, and the filament strands will be unable to bear the weight, resulting in coil deformation and having an adverse effect on uniformity of level of illumination. Furthermore, if the value is extremely large, deformation will result in short-circuiting between coils and coil breakage.

In a light irradiation type heat treatment device having a lamp unit 40 configured in this manner, the filament lamps 10 in the lamp unit 40 are illuminated while the article W to be treated is rotated in a circular direction by a prescribed means. The reason for rotating the article W to be treated is to render the temperature identical in the locations of the zone F1 of the article W to be treated facing the filaments F1 and in the locations of the zone F2 of the article W to be treated facing the filaments F2. By configuring the apparatus in this manner, it is possible to increase the emission intensity E_{F1} from the filaments F1 relative to the emission intensity E_{F2} of the filaments F2, and to make the emission spectrum shape in the filaments F1 identical to the emission spectrum shape in the filaments F2 (see FIG. 14). Accordingly, it is possible to heat the article W to be treated with uniform temperature distribution of the entire surface of the article W to be treated.

Furthermore, in this light irradiation type heat treatment device, by making the effective surface area of each filament F1 identical, and making the effective surface area of each filament F2 identical, the irradiance per unit of surface area emitted onto each of the zones Z1, Z2 becomes identical, as shown in Relationship 3 below, thereby making it possible to heat the article W to be treated with an even more uniform temperature distribution on the article W to be treated.

### (Relationship 3)

Effective surface area of filaments F1 is identical for each.
Effective surface area of filaments F2 is identical for each.

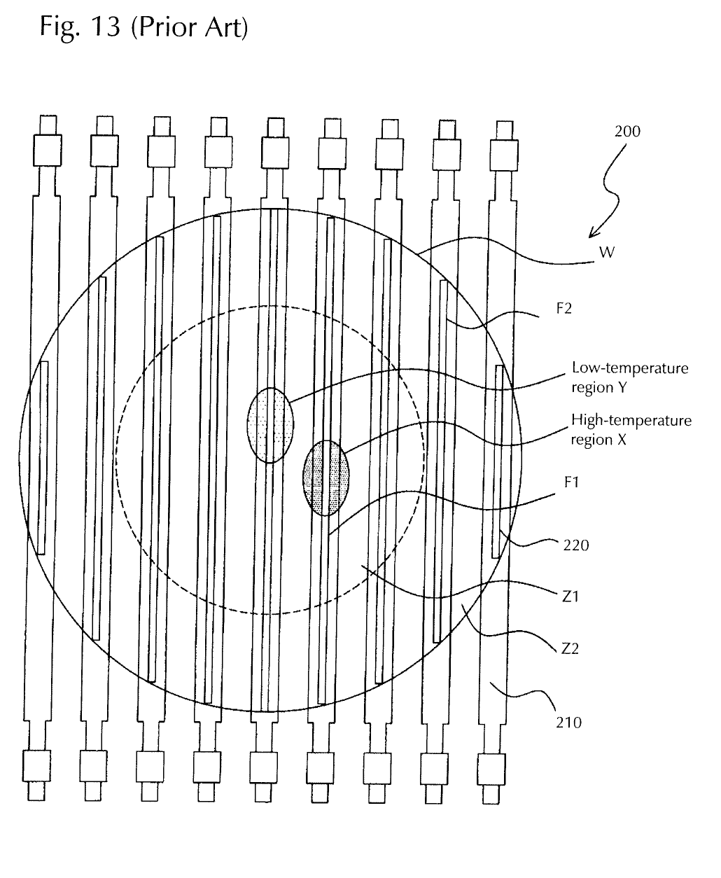

Based on the following circumstances, it is believed to be even more preferable for the light irradiation type heat treatment device to satisfy relationship 3 above. In other words, the light irradiation type heat treatment device is designed with differing respective outer coil diameters, coil pitches, and coil strand diameters so that each of the filaments disposed corresponding to each zone have differing lengths while having the same rated power density. As a result, different filaments F2 disposed facing the center zone Z2 of the article W to be treated have slight individual differences in effective surface area, and slight individual differences in color temperature as a result. Accordingly, it may be conjectured that the emission intensity E emitted from each of the filaments F2 will differ slightly. In this case, as shown in FIG. 13, for example, it may be conjectured that in the zone Z1, an area X in which the temperature of the article to be treated is relatively high and an area Y in which the temperature is relatively low will be formed locally, although the differences will only be slight, resulting in a slight loss of uniform temperature distribution on the surface of the article W to be treated.

Consequently, in a case in which strict consistency of surface temperature is required for the article to be treated, the effective surface area S of the filaments F1 facing the peripheral zone Z1 should be equalized, and the effective surface area S of the filaments F2 facing the center zone Z2 should be equalized, as shown in Relationship 3 above. Of course, if strict consistency of surface temperature for the article to be treated is not required, there is no need to satisfy Relationship 3.

FIGS. 6 & 7 are sectional views taken along a plane including the tube axis of the filaments 20 formed by winding into a coil shape in FIG. 3, unlike the embodiment shown in FIG. 5. These drawings compare the filaments F1 and the filaments F2 shown in FIG. 2.

In FIG. 6, the filaments F1 and the filaments F2 are configured so that the coil pitch of the filaments F1 is smaller than the coil pitch of the filaments F2. But even when configured in this manner, it is still possible to increase the effective surface area S_{F1} of the filaments F1 in relation to the effective surface area S_{F2} of the filaments F2.

Here, the phrase “coil pitch” refers to the distance of a line between the respective center points of two adjacent filament strands in a section in which the filament is portioned into a flat plane including the filament center axis.

Specifically, when the coil pitch of each filament F1 is represented as P_{F1} and the coil pitch of each filament F2 is represented as P_{F2}, it is preferable to configure the filaments F1 and the filaments F2 to satisfy the relationship P_{F1}/P_{F2}=0.5 to 0.85. If the value falls below this range, the distance between the coil loops becomes too small, resulting in short circuiting and breakage. If the value rises above this range, it becomes impossible to obtain the desired surface area, the input power is insufficient, and the temperature at the wafer edge will fall.

In FIG. 7, the filaments F1 and the filaments F2 are configured so that the outer diameter of the filament strands of the filaments F1 is greater than the outer diameter of the filament strands of the filaments F2. However, even when configured in this manner, it is still possible to increase the effective surface area of the filaments F1 in relation to the effective surface area of the filaments F2.

Here, the phrase “outer diameter of the filament strands” refers to the distance between two parallel lines when the outer edge of a filament strand is tangent to two parallel lines, in a section in which the filament is portioned into a flat plane including the filament center axis.

Specifically, when the outer diameter of a filament strand in each filament F1 is represented as φ_{F1} and the outer diameter of a filament strand in each filament F2 is represented as φ_{F2}, it is preferable to configure the filaments F1 and the filaments F2 to satisfy the relationship φ_{F1}/φ_{F2}=1.07 to 1.30. If the value falls below this range, it becomes impossible to obtain the desired surface area, the input power is insufficient, and the temperature at the wafer edge will fall. If the value rises above this range, the gap between the coil strands becomes too small, resulting in short-circuiting and breakage.

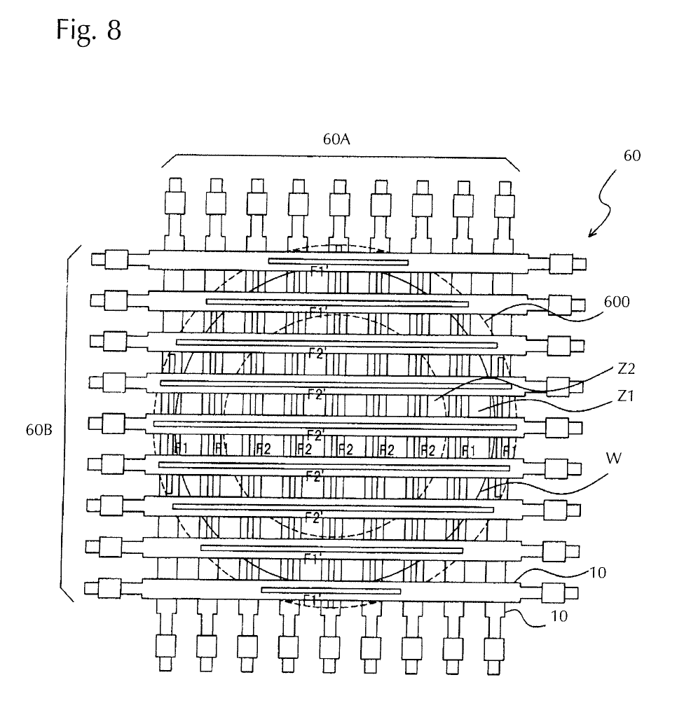

FIG. 8 shows the configuration of a lamp unit 60 configured with the lamp units 40 shown in FIG. 2 disposed in a grid with upper and lower rows, in place of the configuration of the lamp units 40 shown in FIG. 2.

In the lamp unit 40 shown in FIG. 2, the lamp unit 40 has a plurality of filament lamps 10 disposed in a row so that the tube axis of each filament lamp 10 is located on the same plane. The lamp unit 40 is used to heat the article W to be treated with uniform temperature by radiation from each filament lamp onto the article W to be treated, with the article W to be treated rotated in a circular direction. In contrast, in the lamp unit 60 shown in FIG. 8, it is possible to heat the article W to be treated with uniform temperature without rotating the article W to be treated.

In other words, in the lamp unit 60 shown in FIG. 8, the apparatus is configured so that above (on the opposite side of the article W to be treated) a first surface light source 60A, in which a plurality of filament lamps 10 is arranged so the tube axis of each filament lamp 10 is disposed on the same plane, is arranged a second surface light source 60B, in which a plurality of filament lamps 10′ are arranged so the tube axis of each filament lamp 10′ is disposed on the same plane and the tube axis of each filament lamp 10′ bisects the tube axis of each filament lamp 10 at right angles. In other words, the lamp unit 60 is configured with the plurality of filament lamps 10, 10′ disposed in a so-called grid pattern. Also, the ends in the center axis direction of each filament in each of the filament lamps 10, 10′ are disposed to extend over the outside of the imaginary circle 600 on the peripheral edge of the article W to be treated, and are configured with differing total lengths in the center axis direction.

The first surface light source 60A is configured so that the effective surface area S_{F1} of the filaments F1 facing only the peripheral zone Z1 of the article W to be treated is greater than the effective surface area S_{F2} of the filaments F2 facing both the peripheral zone Z1 and the center zone Z2 of the article W to be treated. The second surface light source 60B is configured so that the effective surface area S_{F1′} of the filaments F1′ facing only the peripheral zone Z1 of the article W to be treated is greater than the effective surface area S_{F2′} of the filaments F2′ facing both the peripheral zone Z1 and the center zone Z2 of the article W to be treated. Note that the apparatus is configured so that the effective surface area S_{F1} of the filaments F1 is identical to the effective surface area S_{F1′} of the filaments F1′. Similarly, the apparatus is configured so that the effective surface area S_{F2} of the filaments F2 is identical to the effective surface area S_{F2′} of the filaments F2′.

In the lamp unit 60 shown in FIG. 8, the effective surface area and the rated power density for each filament are set to satisfy relationships 1 and 2 above. By operating all the filament lamps 10, 10′ belonging to the lamp unit 60 with the same color temperature for each filament, it is possible to increase the irradiance per unit of surface area emitted onto the zone Z1 in relation to the irradiance per unit of surface area emitted onto the zone Z2, and it is possible to render identical the shape of the emission spectrum for each filament. As a result, it is possible to heat the article W to be treated with uniform temperature distribution on the surface of the article W to be treated. Furthermore, if the effective surface areas of each of the filaments F1, F1′ are made identical, and if the effective surface areas of each of the filaments F2, F2′ are made identical, it is possible to make the irradiance per unit of surface area emitted onto each of the zones Z1, Z2 identical for each of the zones Z1, Z2.

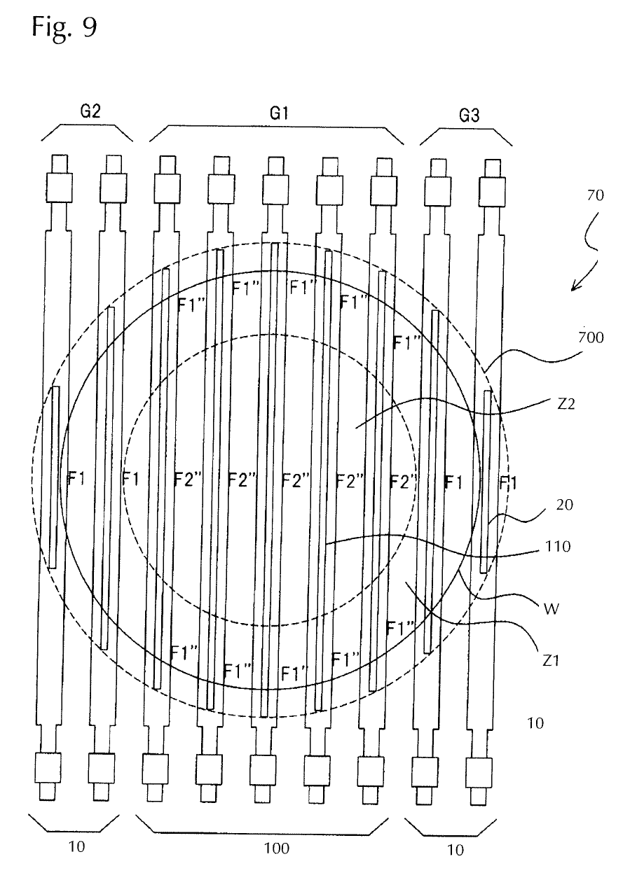

Next, a second embodiment of the present invention will be described with reference to FIGS. 9 & 10.

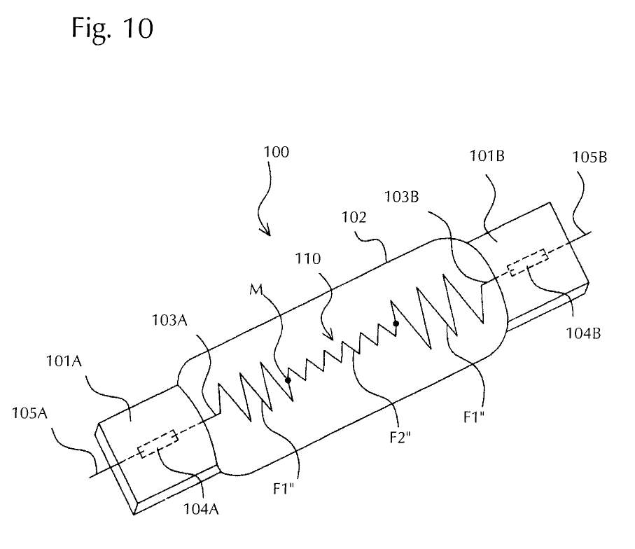

FIG. 9 shows the configuration of a lamp unit 70 applied to the same type of apparatus as the light irradiation type heat treatment device shown in FIG. 1, but having a different configuration from the lamp unit 40 shown in FIG. 2. FIG. 10 shows a perspective view of the configuration of the filament lamp 100 shown in FIG. 9.

As shown in FIG. 9, the lamp unit 70 is configured with a lamp group G1 having a plurality of filament lamps 100 disposed facing both the peripheral zone Z1 of the article W to be treated and the center zone Z2 of the article W to be treated, and lamp groups G2, G3 having a plurality of filament lamps 10 disposed on both sides of the lamp group G1 and facing only the peripheral areas of the article W to be treated. Here, the ends in the center axis direction of each of the filaments 20, 110 of the filament lamps 10, 100 are disposed extending over an imaginary circle 700 on the outside of the peripheral of the article W to be treated, configured with differing total lengths in the center axis direction.

As shown in FIG. 10, the filament lamps 100 belonging to the lamp group G1 have the same configuration as the filament lamps 10 shown in FIG. 3, except for having different filament configurations. In other words, the coil-shaped filaments 110 disposed inside the light emitting tube 102 of the filament lamps 100 are configured with central filaments F2″, each of which disposed in the center between a respective pair of end filaments F1″ which extend from a respective end of the central filaments F2″ and are formed with a larger outer coil diameter than the central filaments F2″. Furthermore, filaments F1″ are configured so that the effective surface area S_{F1″} per unit of length of the end filaments F1″ is greater than the effective surface area S_{F2″} per unit of length of the central filaments F2″. Connected to the ends of each of the end filaments F1″ are leads 103A, 103B connected to respective metal foils 104A, 104B. The filaments 110 are formed by connecting one end of each of the end filaments F1″ to both ends of the central filaments F2″, by a weld spot that is not a light emitting element. Here, the filaments F2″ disposed in the center in the tube axis direction are low-emission coils, while the end filaments F1″ disposed on the edges are high emission coils.

As shown in FIG. 9, in the lamp group G1 having a plurality of filament lamps 100, the end filaments F1″ are disposed facing the peripheral zone Z1 of the article W to be treated, and the central filaments F2″ are disposed facing the center zone Z2 of the article W to be treated.

For their part, the filament lamps 10 of the lamp groups G2, G3 facing the peripheral zone Z1 of the article W to be treated have the same configuration as the filament lamps shown in FIG. 3. The effective surface area S_{F1} per unit of length in the filaments F1 of the filament lamps 10 is the same as the effective surface S_{F1″} of the end filaments F1″, and is greater than the effective surface area S_{F2}″ per unit of area of the central filaments F2″.

According to this lamp unit 70, the effective surface area and the rated power density of each filament are set so as to satisfy relationships 1 and 2 above. As a result, all of the filament lamps 10, 100 belonging to the lamp unit 70 are operated so the color temperature of the filaments is uniform. If the article W to be treated is heated using this lamp unit 70, there is no need to rotate the article W to be treated.

According to this lamp unit 70, directly below the lamp unit 70, the irradiance per unit of surface area emitted onto the peripheral zone Z1 of the article W to be treated can be made greater than the irradiance per unit of surface area emitted onto the center zone Z2 of the article W to be treated, and the form of the emission spectrum for each filament can be rendered identical (see, FIG. 14). Accordingly, it is possible to heat the article W to be treated with a uniform temperature distribution on the surface of the article W to be treated. Furthermore, if the effective surface areas of the filaments F1, F1″ are made identical and the effective surface areas of the filaments F2, F2″ are made identical, as shown in relationship 3 above, it is possible to make the irradiance per unit of surface area emitted onto each of the zones Z1, Z2 identical for each of the zones Z1, Z2.

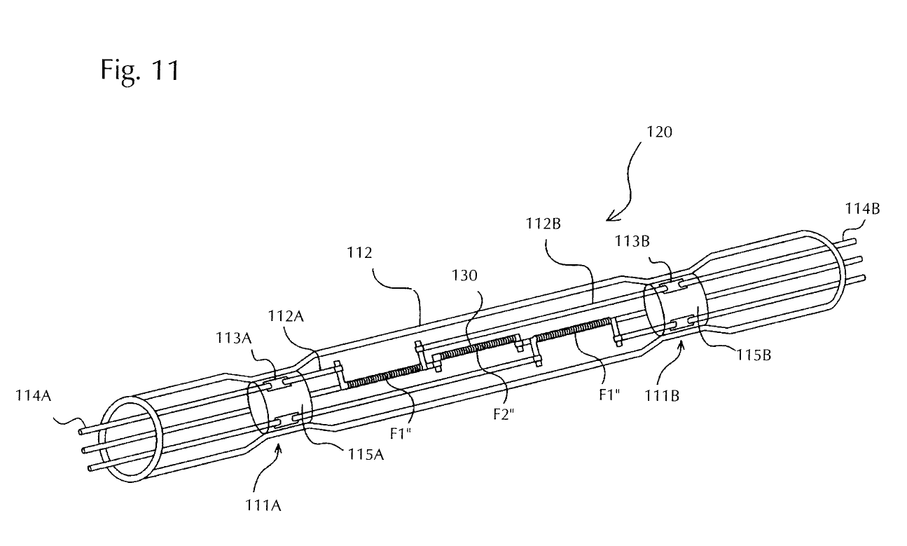

Next, a third embodiment of the present invention will be described using FIGS. 11 & 12.

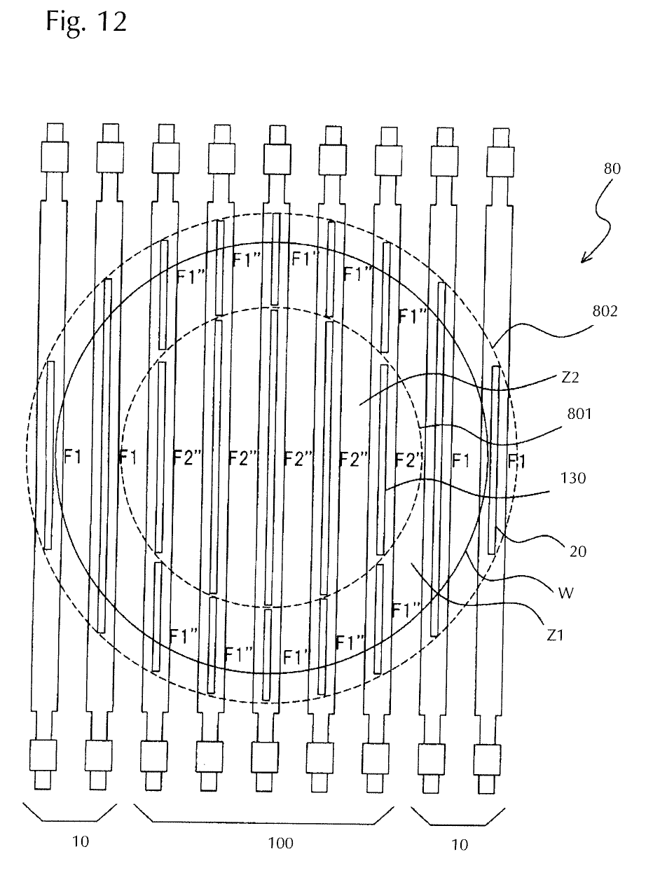

FIG. 11 is a perspective view showing the configuration of a filament lamp 120 according to the present embodiment. FIG. 12 shows the configuration of a lamp unit 80 to which the filament lamp 120 shown in FIG. 11 is applied as a lamp unit.

The filament lamp 120 shown in FIG. 11 has a configuration in which a plurality of filament assemblies having a filament 130 formed into a coil shape and a pair of leads 112A, 112B connected to both ends of the filament are arranged so that the filaments 130 extend sequentially along the tube axis of a light emitting tube 112. On both ends of the light emitting tube 112 are formed hermetically sealed portions 111A, 111B creating an airtight seal by bonding sealing insulators 115A, 115B disposed in the interior of the light emitting tube 112 and the interior surface of the light emitting tube 112 using metal foils 113A, 113B arranged at an appropriate distance apart on the perimeter surface of the sealing insulators 115A, 115B and a number of units double that of the number of filament assemblies. On one end of the metal foils 113A, 113B are connected internal leads 112A. 112B, and on the other end of the metal foils 113A, 113B are connected external leads 114A, 114B, extending from the outer edge surface of the light emitting tube 112 to the exterior and reaching a power supply apparatus not shown in the drawing. As a result, power is supplied from the power supply apparatus to the filament assemblies via the external leads 114A, 114B, the metal foils 113A, 113B, and the internal leads 112A, 112B. In this filament lamp 120, it is possible to supply power independently to each filament 130.

In this filament lamp 120, the effective surface area of the filaments F1″ disposed at the ends in the tube axis direction is greater than the effective surface area of the filaments F2″ disposed in the center in the tube axis direction of the light emitting tube 112. In other words, as shown in FIGS. 5-7, the coil outer diameter of the filaments F1, F1″ is made larger than the coil outer diameter of the filaments F2″, the coil pitch of the filaments F1, F1″ is made smaller than the coil pitch of the filaments F2″, and the coil strand diameter of the filaments F1, F1″ is made larger than the coil strand diameter of the filaments F2″. Here, the filaments F2″ disposed in the center in the tube axis direction are low emission filaments, while the filaments F1″ disposed on the edges are high emission filaments.

The lamp unit 80 shown in FIG. 12 is configured with two units that each comprise the filament lamps 10 with the configuration shown in FIG. 3 and are disposed on both sides of the 5 filament lamps 120 having the configuration shown in FIG. 11, with the tube axes of the filament lamps 10, 120 arranged a prescribed distance apart (15 mm, for instance) on the same plane. Specifically, the filament lamps 10 having the configuration shown in FIG. 3 are arranged corresponding to the peripheral zone Z1 of the article W to be treated, while the filament 120 having a configuration in which a plurality of filaments is disposed inside a light emitting tube are arranged corresponding to the peripheral zone Z1 and the center zone Z2 of the article W to be treated.

According to this lamp unit 80, the filament lamps 120 and the filament lamps 10 are arranged in relation to the article W to be treated as described below. In other words, the filament lamps 120 are arranged with the filaments F2″ disposed in the center in the tube axis direction corresponding to the center zone Z2 of the article W to be treated, and with the filaments F1″ disposed on both ends of the filaments F2″ in the tube axis direction corresponding to the zone Z1 of the article W to be treated. The filament lamps 10 are arranged with the filaments 20 (treated as filaments F1) corresponding to the zone Z1 of the article W to be treated.

The filaments F2″ of the filament lamps 120 have differing total lengths in the tube axis direction, while the imaginary circle 801 formed connecting the ends in the tube direction of the filaments F2″ is arranged in relation to the article W to be treated to match the exterior edge of the center zone Z2 of the article W to be treated. In addition, the filaments F1″ of the filament lamps 120 and the filaments F1 of the filament lamps 10 have differing total lengths in the tube axis direction, and are arranged so that one end of each filament F1″ is disposed on the outer edge of an imaginary circle 801 and the other end is disposed on the outer edge of an imaginary circle 802 formed on the outside of the peripheral of the article W to be treated, with both ends of the filaments F1 arranged on the outer edge of the imaginary circle 802.

In addition, in the filaments of the filament lamp 120 that comprise the lamp unit 80, as shown in FIGS. 5-7, the coil outer diameter of the filaments F1, F1″ is made larger than the coil outer diameter of the filaments F2″, the coil pitch of the filaments F1, F1″ is made smaller than the coil pitch of the filaments F2″, and the coil strand diameter of the filaments F1, F1″ is made larger than the coil strand diameter of the filaments F2″.

According to this lamp unit 80, the effective surface area and the rated power density of each filament are set so as to satisfy relationships 1 and 2 above. All of the filament lamps 10, 100 belonging to the lamp unit 80 are operated so the color temperature of the filaments is uniform. If the article W to be treated is heated using this lamp unit 80, there is no need to rotate the article W to be treated.

Therefore, in the light irradiation type heat treatment device according to the present embodiment, directly below the lamp unit 80, the irradiance per unit of surface area emitted onto the peripheral zone Z1 of the article W to be treated can be made greater than the irradiance per unit of surface area emitted onto the center zone Z2 of the article W to be treated, and the form of the emission spectrum for each filament can be rendered identical (see, FIG. 14). Accordingly, it is possible to heat the article W to be treated with a uniform temperature distribution on the surface of the article W to be treated. Furthermore, if the effective surface areas of the filaments F1, F1″ are made identical and the effective surface areas of the filaments F2, F2″ are made identical, as shown in relationship 3 above, it is possible to make the irradiance per unit of surface area emitted onto each of the zones Z1, Z2 identical for each of the zones Z1, Z2.

What is claimed is:

1. A filament lamp, comprising:
a light emitting tube, a coil-shaped filament disposed extending along the tube axis in the light emitting tube,
wherein the coil-shaped filament comprises a high radiance coil having a relatively large effective surface area which is electrically connected to a low radiance coil having a relatively small effective surface area at each of opposite ends of the high radiance coil in a longitudinal direction of the light emitting tube.

2. A filament lamp, comprising:
a light emitting tube,
a plurality of filaments in the interior of said light emitting tube and to which a pair of leads are electrically connected via electrically conductive parts disposed in a hermetically sealed portion formed on at least one end of the light emitting tube, each filament extending along a longitudinal axis of the light emitting tube,
wherein the coil-shaped filament comprises a low radiance coil having a relatively small effective surface area which is disposed in a center in the tube axis direction,
a high radiance coil having a relatively large effective surface area which is disposed at an end of the direction of the tube axis of the light emitting tube at both sides of the low radiance coil.

3. A light irradiation type heat treatment device, comprising:
a plurality of filament lamps in which coil-shaped filaments extend inside a light emitting tube along a longitudinal axis thereof,
wherein said lamps are disposed so as to form a surface light source,
wherein, in each of the filament lamps, the effective surface area per unit length of the filaments disposed in an area corresponding to an outer edge zone of an article to be treated is greater than an effective surface area per unit length of filaments disposed in an area corresponding to a center zone of the article to be treated.

4. The light irradiation type heat treatment device of claim 3, wherein an external diameter of each of the filament coils disposed in the area corresponding to the outer edge zone of the article to be treated is larger than the external diameter of each of the filament coils disposed in the area corresponding to the center zone of the article to be treated.

5. The light irradiation type heat treatment device of claim 3, wherein the pitch of each of the filament coils disposed in the area corresponding to the outer edge zone of the article to be treated is smaller than the pitch of each of the filament coils disposed in the area corresponding to the center zone of the article to be treated.

6. The light irradiation type heat treatment device of claim 3, wherein the strand diameter of each of the filament coils disposed in the area corresponding to the outer edge zone of the article to be treated is larger than the strand diameter of each of the filament coils disposed in the area corresponding to the center zone of the article to be treated.

7. The light irradiation type heat treatment device of claim 3, wherein each of the filaments disposed in the area corresponding to the outer edge zone of the article to be treated and each of the filaments disposed in an area corresponding to the center zone of the article to be treated has the same effective surface area in each of the respective zones.

8. A light irradiation type heat treatment device, having:
a plurality of filament lamps, each of which comprises:
a light emitting tube,
a plurality of filaments in the interior of said light emitting tube and to which a pair of leads are electrically connected via electrically conductive parts disposed in a hermetically sealed portion formed on at least one end of the light emitting tube, each filament extending along a longitudinal axis of the light emitting tube,
wherein, in each of the filament lamps, the effective surface area per unit length of the filaments disposed in an area corresponding to an outer edge zone of an article to be treated is greater than an effective surface area per unit length of filaments disposed in an area corresponding to a center zone of the article to be treated.

9. The light irradiation type heat treatment device of claim 8, wherein an external diameter of each of the filament coils disposed in an area corresponding to an outer edge zone of the article to be treated is larger than the external diameter of each of the filament coils disposed in a center zone of the article to be treated.

10. The light irradiation type heat treatment device of claim 8, wherein the pitch of each of the filament coils disposed in the area corresponding to the outer edge zone of the article to be treated is smaller than the pitch of each of the filament coils disposed in the center zone of the article to be treated.

11. The light irradiation type heat treatment device of claim 8, wherein each of the filaments located in the area corresponding to the outer edge zone of the article to be treated has a strand diameter that is greater than the strand diameter of each of the filament coils disposed in the center zone of the article to be treated.

12. A light irradiation type heat treatment device, comprising:
a plurality of filament lamps in which coil-shaped filaments extend inside a light emitting tube along a longitudinal axis thereof,
wherein said lamps are disposed so as to form a surface light source,
wherein the coil-shaped filaments comprise a high radiance coil having a relatively large effective surface area which is electrically connected to a low radiance coil having a relatively small effective surface area at each of opposite ends of the high radiance coil in a longitudinal direction of the light emitting tube, and wherein said low radiance coil is disposed facing the center of the article to be treated, and said high radiance coil is disposed facing the outer edge of the article to be treated.

13. The light irradiation type heat treatment device of claim 12, wherein an external diameter of the high radiance coil is larger than the external diameter of the low radiance coil.

14. The light irradiation type heat treatment device of claim 12, wherein the coil of the high radiance coil has a pitch which is smaller than the pitch of the low radiance coil.

15. The light irradiation type heat treatment device of claim 12, wherein the strand diameter of the high radiance coil is larger than the strand diameter of the low radiance coil.

16. The light irradiation type heat treatment device of claim 15, wherein each of the filaments disposed in the area corresponding to the outer edge zone of the article to be treated and each of the filaments disposed in an area corresponding to the center zone of the article to be treated has the same effective surface area in each of the respective zones.

17. The light irradiation type heat treatment device of claim 12, wherein each of the filaments disposed in the area corresponding to the outer edge zone of the article to be treated and each of the filaments disposed in an area corresponding to the center zone of the article to be treated has the same effective surface area in each of the respective zones.
